(19) United States
(12) Patent Application Publication
(10) Pub. No.: US 2007/0151526 A1
(43) Pub. Date: Jul. 5, 2007

(54) DIESEL ENGINE SYSTEM

(76) Inventors: David Colbourne, Ince Chester (GB); David John Wedlock, Ince Chester (GB)

Correspondence Address: SHELL OIL COMPANY, P O BOX 2463, HOUSTON, TX, 772522463, US

(21) Appl. No.: 11/565,473

(22) Filed: Nov. 30, 2006

(30) Foreign Application Priority Data
Dec. 2, 2005 (EP) 05111614.3

(51) Int. Cl. F02B 43/00

(52) U.S. Cl. 123/1 A; 208/19; 508/110

(57) ABSTRACT

A diesel engine system comprising a diesel engine provided with a crankcase comprising a crankcase lubricating oil, an air intake, an air compressor, an effluent turbine, an after cooler, and a blow by gas recirculation system comprising a conduit to recirculate the blow-by gas to the air intake, wherein the crankcase lubricating oil comprises an iso-paraffinic base oil having a saturates content of greater than 99 wt % and a viscosity index of greater than 120, a performance additive package system, and a viscosity modifier additive.

### CROSS-REFERENCE TO RELATED APPLICATION

This application claims the benefit of European Patent Application No. 05111614.3, filed Dec. 2, 2005, which is incorporated herein by reference.

### FIELD OF INVENTION

The present invention relates to a diesel engine system comprising a diesel engine provided with a crankcase comprising a crankcase lubricating oil, an air intake, an air compressor, an effluent turbine and an after cooler.

### BACKGROUND OF THE INVENTION

Diesel engines provided with a crankcase, crankcase lubricating oil, an air intake, an air compressor, an effluent turbine and an after cooler are described in U.S. Pat. No. 6,102,013. A problem with crankcase lubricating oils is that they tend to escape from the crankcase with the so-called blow by gases. Rather than vent these blow by gases to the atmosphere, it is preferred to re-circulate the gas/lubricant mixture to the engine. This recirculation is performed in some engines by injecting the blow by gasses to the engine's air intake system such that the lubricant is combusted in the piston chambers. Although recirculation of blow by gasses solves the problem of emmissions it does have its own problems. Deposits may form in the air intake system. If for example deposits form in the air compressor it is easily accepted that such a compressor will malfunction and even be damaged. If for example an air cooler is present between the compressor and the cylinder block-crankcase, fouling of the air cooler can also take place.

The present invention provides a diesel engine system wherein the formation of deposits are avoided or at least further reduced as compared to the diesel engine system of the prior art.

### SUMMARY OF THE INVENTION

In a preferred embodiment, a diesel engine system comprising a diesel engine is provided with a crankcase comprising a crankcase lubricating oil, an air intake, an air compressor, an effluent turbine, an after cooler, and a blow by gas recirculation system comprising means to recirculate the blow-by gas to the air intake, wherein the crankcase lubricating oil comprises an iso-paraffinic base oil having a saturates content of greater than 99 wt % and a viscosity index of greater than 120, a performance additive package system, and a viscosity modifier additive.

The present invention further relates to the use of a lubricating oil comprising an iso-paraffinic base oil having a saturates content of greater than 99 wt % and a viscosity index of greater than 120, a performance additive package system, and a viscosity modifier additive, for the reduction of deposits in a diesel engine system comprising a diesel engine provided with a crankcase comprising a crankcase lubricating oil, an air intake, an air compressor, an effluent turbine, an after cooler, and a blow by gas recirculation system comprising means to recirculate the blow-by gas to the air intake.

The present invention further relates to a process for operating a diesel engine system comprising a diesel engine provided with a crankcase comprising a crankcase lubricating oil, an air intake, an air compressor, an effluent turbine, an after cooler, and a blow by gas recirculation system comprising means to recirculate the blow-by gas to the air intake, wherein the crankcase lubricating oil comprises an iso-paraffinic base oil having a saturates content of greater than 99 wt % and a viscosity index of greater than 120, a performance additive package system, and a viscosity modifier additive.

### BRIEF DESCRIPTION OF THE DRAWING

FIG. 1 illustrates a preferred diesel engine system according to the present invention.

### DETAILED DESCRIPTION OF THE INVENTION

Applicants found that when a crankcase lubricating oil is used according the claimed invention lower values for the so-called MTU deposit testing are achieved.

The crankcase lubricating oil preferably has a kinematic viscosity at 100° C. of between 9.3 and 16.3 cSt. The crankcase lubricating oil preferably comprises a blend of two iso-paraffinic base oils each having a saturates content of greater than 99 wt % and a viscosity index of greater than 120 and preferably between 120 and 150. The first base oil preferably has a kinematic viscosity at 100° C. of between 3 and 6 cSt. The second iso-paraffinic base oil preferably has a saturates content of greater than 99 wt %, a viscosity index of greater than 135 and a kinematic viscosity at 100° C. of greater than 7 cSt.

More preferably the first iso-paraffinic base oil comprises paraffin compounds and less than 15 wt % naphthenic compounds, wherein the naphthenic compounds are of the general formula:
alkyl-[C₅ or C₆-ring]
and wherein the percentage of carbon in the branches of said iso-paraffins and in the alkyl group of said naphthenic compound as calculated relative to all carbon in the compound and measured by NMR is between 12 and 18%.

More preferably the second iso-paraffinic base oil comprises paraffin compounds and less than 15 wt % naphthenic compounds, wherein the naphthenic compounds are of the general formula:
alkyl-[C₅ or C₆-ring]
and wherein the percentage of carbon in the branches of said iso-paraffins and in the alkyl group of said naphthenic compound as calculated relative to all carbon in the compound and measured by NMR is between 12 and 20%.

The weight ratio between the first and the second base oil will depend on the target lubricating oil grade and on the viscometric properties of the starting base oils. Generally the majority, suitably more than 50 wt % of the oil formulation will be comprised of the second base oil.

The above iso-paraffinic base oils are known and described in for example EP-A-1029029, US-A-2004/0043910, US-A-2004/0067856, US-A-2004/0077505, WO-A-02064710 and WO-A-02070631. Applicants found that base oils which perform very well in the crankcase oil formulation described above are obtainable by a process involving a hydroisomerisation step and a catalytic dewaxing step or a combination of said steps on a feedstock obtained in a Fischer-Tropsch process. Examples of suitable processes are exemplified in the above cited patent publications.

The viscosity modifier additive may be a standard type such as olefin copolymers or hydrogenated isoprene or hydrogenated isoprene copolymers. Examples are Infineum SV-151, which is a hydrogenated isoprene-styrene co-polymer, as obtainable from Infineum Additives, Milton Hill, U.K. The viscosity modifier additive is preferably present in the oil formulation in a content of between 6 and 16 wt % more preferably between 6 and 10 wt %. Applicant found that when the base oils described above are used, less of the viscosity modifier additive is required than when the state of the art mineral derived Group III base oils are used to arrive at the same viscometric properties of the resulting oil formulation.

The performance additive package system present in the the crankcase lubricating oil can comprise dispersants, detergents, extreme pressure/antiwear additives, antioxidants, pour point depressants, demulsifiers, corrosion inhibitors, rust inhibitors, antistaining additives, friction modifiers. Specific examples of such additives are described in for example Kirk-Othmer Encyclopedia of Chemical Technology, third edition, volume 14, pages 477-526.

Suitably the anti-wear additive is a zinc dialkyl dithiophosphate. Suitably the dispersant is an ashless dispersant, for example polybutylene succinimide polyamines or Mannic base type dispersants. Suitably the detergent is an over-based metallic detergent, for example the phosphonate, sulfonate, phenolate or salicylate types as described in the above referred to General Textbook. Suitably the antioxidant is a hindered phenolic or aminic compound, for example alkylated or styrenated diphenylamines or ionol derived hindered phenols. Examples of suitable antifoaming agents are polydimethylsiloxanes and polyethylene glycol ethers and esters.

The content of the performance additive package in the crankcase lubricating oil is suitably between 4 and 20 wt % and more preferably between 10 and 16 wt %.

The performance additive packages are commercially available from many vendors and typically have the following composition comprising:
Dispersant additive between 40 and 70 wt % ,
Over-based plus non-over based detergent additives between 15 and 50 wt % ,
Diluent Oil between 30 and 50 wt % ,
Anti wear additive between 3 and 8 wt % .

The crankcase lubricating oil preferably has a dynamic viscosity at −25° C. of between 6500 and <7000 cP, a mini rotary viscometer test value of below 60000 cP at −30° C. In the context of the present invention the following test methods are to be applied. Kinematic viscosity at 100° C. as determined by ASTM D 445, Kinematic viscosity at 40° C. as determined by ASTM D 445, Viscosity Index as determined by ASTM D 2270, VDCCS @ −25° C. stands for dynamic viscosity at −25 degrees Centigrade and is measured according to ASTM D 5293, MRV (cP @ −40° C.) stands for mini rotary viscometer test and is measured according to ASTM D 4684, pour point according to ASTM D 97, Noack volatility as determined by ASTM D 5800.

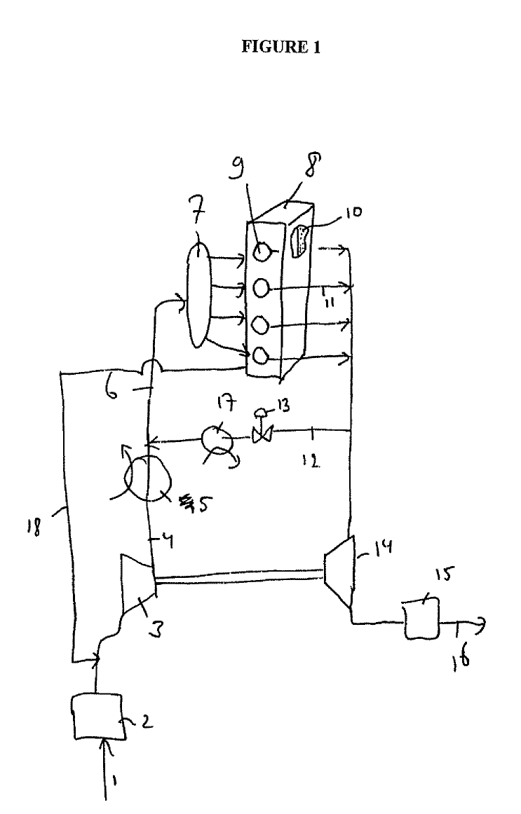

Reference is next made to FIG. 1 which illustrates a preferred embodiment of the present invention. The system in FIG. 1 comprises an air intake (1), an air intake filter (2), an air compressor (3), a conduit (4) for compressed air, an after cooler (5), an inlet manifold (7), a crankcase (8), provided with cylinders (9) and crankcase oil (10) present in the crankcase (8). Conduits (11) fluidly connect the cylinders (9) to an effluent turbine (14). Through conduits (11) exhaust gases flow. Effluent turbine (14) runs in line with the air compressor (3) as shown. The exhaust gases pass an exhaust silencer (15) fluidly connected to an exhaust (16).

The diesel engine system is provided with conduit(12) to recirculate part of the exhaust gasses to the cylinders. In such a system an exhaust flow control valve (13) and a exhaust gas recirculation cooler (17) are present. In addition, a conduit (18) is present to direct the blow-by gases to the air flow just upstream of the air compressor (3).

The invention shall be illustrated by the following non-limiting examples.

### EXAMPLE 1

### Preparation of the Base Oils and Characterization

From a hydroisomerised Fischer-Tropsch wax a distillation fraction was isolated having the properties as listed in Table 1. The wax content was less than 20 wt % as determined by solvent dewaxing at a dewaxing temperature of −20° C.

TABLE 1

| Feed to catalytic dewaxing | | |
|---|---|---|
| Congealing Point | ° C. | +45 |
| Density at 70° C. | | 0.7960 |
| IBP % m distilled as performed | ° C. | 362 |
| by TBP-GLC | | |
| 5 | ° C. | 401 |
| 10 | ° C. | 412 |
| 50 | ° C. | 462 |
| 70 | ° C. | 487 |
| 90 | ° C. | 519 |
| 95 | ° C. | 531 |
| FBP | ° C. | 573 |

The above distillate, also referred to as waxy raffinate, was contacted with a dewaxing catalyst consisting of 0.7 wt % platinum, 25 wt % ZSM-12 and a silica binder. The dewaxing conditions were 40 bar hydrogen, 312° C. reactor temperature, WHSV=1 kg/1.h, and a hydrogen gas rate of 500 Nl/kg feed. The effluent was distilled and a fraction boiling above 390° C. was obtained having the properties of the first base oil of Table 2. Part of the first base oil was further distilled to isolate a fraction boiling above 460° C. (cut off temperature) to obtain the second iso-paraffinic base oil of Table 2. The remaining oil boiling below 460° C. had a kinematic viscosity at 100° C. of 4 cSt.

TABLE 2

| | First | Second |
|---|---|---|
| | base oil | base oil |
| Kinematic viscosity at 100° C. | 5.143 | 7.77 |
| Viscosity index | 144 | 148 |
| Pour point | −24 | −24 |
| Saturates content (wt %) | 99.6 | 99.2 |
| Wt % naphthenic compounds | 5.8 | 8.5 |
| % carbon in the branches | 13.5 | 13.8 |

Measurement of Wt % Naphthenic Compounds

The content of the naphthenic compounds was performed using the FIMS method as described in more detail on pages 27 and 28 of WO-A-2005/000999.

Measurement of The Percentage Carbon in The Branches

This property is measured using C13-NMR. The raw data is taken from a CH₃ subspectrum obtained using the well known GASPE pulse sequence as described in, “Quantitative estimation of CHₙ group abundance in fossil fuel materials using 13-C NMR methods” (D. J. Cookson and B. E. Smith, Fuel (1983) vol. 62, page 986) and also “Improved methods for assignment of multiplicities in 13-C NMR spectroscopy with applications to the analysis of mixtures” (D. J. Cookson and B. E. Smith, Organic Magnetic Resonance, vol. 16, <2>, 1981 page 111). The object is to quantify the proportions of C2 (methyl), C₂ (ethyl) and C₃₊ (3 or more carbon) branches in the sample such that the total number of carbons in the branches can be quantified.

The starting point is a GASPE CH3 subspectrum, which is obtained by addition of a CSE spectrum (standard spin echo) to a 1/J GASPE (gated acquisition spin echo). This gives a spectrum which contains CH₃ and CH peaks only. We then define the CH₃'s as being the signals to low frequency of 25 ppm chemical shift (referenced against TMS). This subspectrum is then integrated to give quantitative values for the various different CH₃ signals.

Many of the CH3 signals can be specifically identified, but in some cases assignment is less clear cut and certain assumptions have to be made as outlined below.

Calculation of Methyl Branch Content

A number of signals can be assigned to methyl branches. Between 19 and 21ppm there are number of distinct and intense signals which can be identified as methyl branches of the following general type 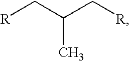
wherein R=alkyl group.

Also observed are distinct intense signals in the region of 22 to 24 ppm which can be unambiguously identified as isopropyl end groups of the following general structure.

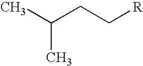

In this instance we can class one of the CH₃'s as being the termination of the main chain and the other as being a branch. Therefore when calculating methyl branch content the intensity of these signals must be halved.

There are also several weak signals in the region of 15 to 19ppm. It is entirely possible that this region would contain signals belonging to an isopropyl group with an additional branch in the 3 position:

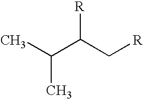

In this instance the integral value for these signals would also have to be halved when calculating methyl branch content. However there is little other evidence for these structures and the region will also contain structures with methyl branches adjacent to other branches, i.e.:

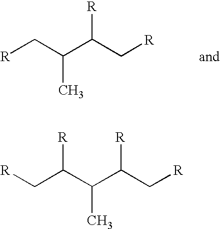

Due to this ambiguity we have decided to make the assumption that the majority of these signals are methyl branches adjacent to other branches, and use the integral value undivided. If there were in fact a significant quantity of isopropyl groups with an additional branch in the 3 position, this would mean that our calculation would overestimate the methyl branch content. However it is important to note that the signals in this region are weak relative to the other CH₃ signals and consequently the difference in methyl branch content would be small.

Also observed in the spectrum are some very weak signals in the region 8 to 8.5 ppm. Our only potential assignment for these signals is for 3,3-dimethyl substituted structures:

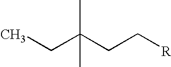

In this case the observed signal is for the terminal CH₃, but there are two corresponding methyl branches. Therefore the integral value of these signals needs to be doubled. (the signals for the two methyl branches are not counted independently).

Overall our estimation of methyl branch content is based on the following calculation
Int 19 to 20 ppm +(Int 22 to 25 ppm)/2 +Int 15 to 19 ppm +(int 7.0 to 9 ppm)*2
Calculation of Ethyl Branch Content

This is somewhat simpler than calculation of the methyl branch content.

Two distinct relatively intense signals can be observed. The signal at 11.5 ppm can be assigned as the 3-methyl substituted structure.

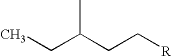

In this instance the CH₃ signal can be classed as termination of the main chain and discounted as being part of the ethyl branch content. (The corresponding signal for the methyl branch is observed at 19.3 ppm and is therefore already being included in the methyl branch content).

A signal at 10.9 ppm can be assigned as a pendant methyl of the general type: 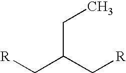
and consequently its integral can be used directly to calculate ethyl branch content.

The only slight problem here is that isopentyl end groups: 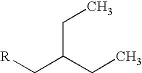
would give a signal in the same region and, as one of the CH₃'s would need to be classed as termination of the main chain, the integral value would need to be halved. However the evidence from other peak assignments for the above structure suggests that isopentyl content is very low. Therefore we assume it to be negligible and use the integral for this signal directly without sub-division. It is possible that if there were in fact significant isopentyl content that we could be overestimating the ethyl branch content.

Overall our calculation of ethyl branch content is based solely on Int 10 to 11.2 ppm.

Calculation of C₃₊branch content

This is the most the most difficult to calculate and cannot be obtained solely from the NMR data. The problem is the difficulty of differentiating between the CH₃ signal for these longer branches and the CH₃ signals for the termination of the main chain. The signals we observe for these carbons is in the region 14 to 15 ppm.

A smaller signal at 14.7ppm may be due to C₃ branches.

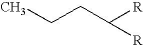

However we do not have reliable data to confirm this.

A second smaller signal at 14.5 ppm can be assigned to 4-methy structures, i.e. 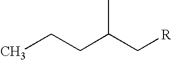
and therefore is CH3 terminating the main chain.

The major signal in this region is at 14.1 ppm and tends to be one of the most intense signals in the spectrum. This can be assigned to any CH₃ without a branch within 4 carbons i.e. 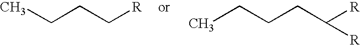
as can be seen it is not possible to distinguish between termination of the main chain and longer branches within this signal.

Because of this difficulty our approach has been to calculate the theoretical content for CH₃'s terminating the main chain. This is done with reference to the above FIMS data. For example FIMS gives us a proportion of Z2 molecules along with an average carbon number for those structure. A Z2 molecule can be defined as linear or branched hydrocarbon and in either case by definition will have two terminal CH₃'s. As we know the “Z” content and the average carbon number we can therefore calculate the theoretical main chain terminating CH₃ content due to Z2 structures. Similarly we have the proportion and average carbon numbers for the Z0 or lower structures (i.e. Z0, Z-2, Z-4 etc). In the iso-paraffinic base oil the aromatic and olefinic content is very low, such that it can be assumed that Z0 or less structures are cyclic, for example of the following type:

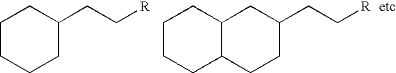

We therefore make the assumption that these structures have one CH₃ terminating the main chain. Of course it is possible that we could have Z0 or lower structures which are different to the above. For example with a ring at either end of the chain or a ring in the middle of the chain. However as we have no means of distinguishing such structures and we feel that they may be less likely to occur than the above, we feel that our assumption of one terminal CH₃ per molecule is the best we can make.

With this information we calculate what the overall theoretical terminal CH₃ content should be for the sample. If we subtract from this value the known terminal CH₃ contents i.e. half of the isopropyl value, the 3-methyl substituted value and the value for 3,3-di methyl substituted structures , we arrive at a value for the signals in the 14 ppm region which belong to CH₃'s terminating the chain, the difference being the value for the C₃₊ branches

Therefore our calculation for C₃₊ branches is
Int 14-15 ppm−((theoretical terminal CH₃)−(int 11.2 to 11.8)−(int 22 to 25 ppm)/2−int 7 to 9 ppm))

As can be seen a number of assumption have to be made in the course of calculating proportion of branching types. Applicant believes at present that the above is the best method we have been able to devise.

### EXAMPLE 2

A 10W40 crankcase engine oil was formulated using the base oils from Table 2 wherein the final formulation comprised 3 wt % of the first base oil, 67.9 wt % of the second base oil, 8.9 wt % of a commercially available viscosity modifier additive and 20.2 wt % of a standard additive package not containing a viscosity modifier.

This crankcase oil formulation was subjected to the MTU Deposit test, a standard test method described (DIN 51535), part of the MTU Engine Oils for Diesel Engines specification MTL 5044 (January 2004). The MTU deposit test resulted in a deposit test value of 105 mgs deposits.

Comparative Experiment

A 10W40 crankcase oil formulation having the same kinematic viscosity at 100° C. as in Example 1 was formulated using two mineral derived base oils having the properties listed in Table 3. The final formulation comprised of 24.5 wt % XHVI-5 and 43.9 wt % XHVI-8. The oil further contained 11.4 wt % of the viscosity modifier additive and 20.2 wt % of a standard additive package not containing a viscosity modifier.

This crankcase oil formulation was subjected to the MTU Deposit test of Example 1 resulting in a MTU deposit test value of 141 mgs deposits.

The lower MTU test value of example 2 as compared to this experiment is a significant indicator that less deposits will form in the air intake system or in the optional air cooler.

1. A diesel engine system comprising a diesel engine provided with a crankcase comprising a crankcase lubricating oil, an air intake, an air compressor, an effluent turbine, an after cooler, and a blow by gas recirculation system comprising a conduit to recirculate the blow-by gas to the air intake, wherein the crankcase lubricating oil comprises an iso-paraffinic base oil having a saturates content of greater than 99 wt % and a viscosity index of greater than 120, a performance additive package system, and a viscosity modifier additive.

2. A diesel engine system according to claim 1, wherein the crankcase lubricating oil has a kinematic viscosity at 100° C. of between 9.3 and 16.3 cSt.

3. A diesel engine system according to claim 1, wherein crankcase lubricating oil comprises a first iso-paraffinic base oil having a saturates content of greater than 99 wt % , a viscosity index of between 120 and 150 and a kinematic viscosity at 100° C. of between 3 and 6 cSt and a second iso-paraffinic base oil having a saturates content of greater than 99 wt % , a viscosity index of greater than 135 and an kinematic viscosity at 100° C. of greater than 7 cSt.

4. A diesel engine system according to claim 3, wherein the second iso-paraffinic base oil comprises paraffinic compounds and less than 15 wt % naphthenic compounds, wherein the naphthenic compounds are of the general formula:
alkyl-[C₅ or C₆-ring]
and wherein the percentage of carbon in the branches of said iso-paraffins and in the alkyl group of said naphthenic compound as calculated relative to all carbon in the compound is between 12 and 20%.

5. A diesel engine system according to claim 4, wherein the first iso-paraffinic base oil comprises paraffin compounds and less than 15 wt % naphthenic compounds, wherein the naphthenic compounds are of the general formula:
alkyl-[C₅ or C₆-ring]
and wherein the percentage of carbon in the branches of said iso-paraffins and in the alkyl group of said naphthenic compound as calculated relative to all carbon in the compound is between 12 and 18%.

6. A diesel engine system according to claim 1, wherein the iso-paraffin base oil is the reaction product of a hydroisomerisation process which process is fed with a paraffinic feedstock.

7. A diesel engine system according to claim 6, wherein the paraffin feedstock is a Fischer-Tropsch wax.

8. A method for the reduction of deposits in a diesel engine system comprising a diesel engine provided with a crankcase comprising a crankcase lubricating oil, an air intake, an air compressor, an effluent turbine, an after cooler, and a blow by gas recirculation system comprising a conduit to recirculate the blow-by gas to the air intake, the method comprising use of a lubricating oil comprising an iso-paraffinic base oil having a saturates content of greater than 99 wt % and a viscosity index of greater than 120, a performance additive package system, a viscosity modifier additive.

9. A process for operating a diesel engine system comprising a diesel engine provided with a crankcase comprising a crankcase lubricating oil, an air intake, an air compressor, an effluent turbine, an after cooler, and a blow by gas recirculation system comprising a conduit to recirculate the blow-by gas to the air intake, wherein the crankcase lubricating oil comprises an iso-paraffinic base oil having a saturates content of greater than 99 wt % and a viscosity index of greater than 120, a performance additive package system, and a viscosity modifier additive.
